(19) United States
(12) Patent Application Publication
(10) Pub. No.: US 2011/0087139 A1
(43) Pub. Date: Apr. 14, 2011

(54) BODY MASSAGERS

(75) Inventors: Roman S. Ferber, West Bloomfield, MI (US); Elizabeth Harrison-Meyer, Chicago, IL (US)

(73) Assignee: FKA DISTRIBUTING CO. D/B/A HOMEDICS, INC., Commerce Township, MI (US)

(21) Appl. No.: 12/992,967

(22) PCT Filed: May 28, 2009
(86) PCT No.: PCT/US09/45397

§ 371 Date: Nov. 16, 2010

Related U.S. Application Data
(60) Provisional application No. 61/056,572, filed on May 28, 2008.

(51) Int. Cl. A61H 7/00

(52) U.S. Cl. 601/134

(57) ABSTRACT

A body massager is provided with a housing. A carriage translates in an upper torso region of the housing. A first massager on the carriage extends in a forward direction from the housing. A second motor-driven massager is mounted to the housing at a lower torso region and extends in the forward direction from the housing further than the first motor-driven massager. Another body massager provides a guide with a longitudinal region and a transverse region. Another body massager provides a suspension on the carriage. Another body massager provides a plate on the carriage for supporting a massage member. An actuator is mounted to the carriage for adjusting the plate. Another body massager provides a contoured guide with an actuator for adjusting the guide. Another body massager provides a transversely contoured guide. Another body massager provides a contoured guide that extends forward in upper and lower torso regions.

### CROSS-REFERENCE TO RELATED APPLICATIONS

This application claims the benefit of U.S. provisional application Ser. No. 61/056,572 filed May 28, 2008, the disclosure of which is incorporated by reference herein.

### BACKGROUND

1. Technical Field

Various embodiments of the invention relate to body massagers.

2. Background Art

The prior art has provided various massagers, including massagers with a housing, a carriage in the housing for translation in the housing, and a massage assembly on the carriage. Examples of carriage massagers include U.S. Pat. No. 7,128,721 B2, which issued to Ferber et al. on Oct. 31, 2006, and U.S. Pat. No. 7,470,242 B2, which issued to Ferber et al. on Dec. 30, 2008.

### SUMMARY

One embodiment discloses a body massager with a backrest housing sized to be received and supported by a backrest of a conventional chair. A seat support is pivotally connected to the backrest housing. A carriage is oriented in the housing and cooperates with the housing for longitudinal translation in an upper torso region of the housing. A first motor-driven massager is mounted on the carriage and extends in a forward direction from the housing for imparting a first kneading massage effect. A second motor-driven massager is mounted to the housing at a lower torso region between the first region and the seat bottom. The second motor-driven massager extends in the forward direction from the housing further than the first motor-driven massager for imparting a second kneading massage effect.

Another embodiment discloses a body massager with a housing having an external contact surface for receiving a portion of a body of a user. A carriage is oriented in the housing and cooperates with the housing for longitudinal translation in a longitudinal direction of the housing. A guide is mounted to the housing and has a first region extending in the longitudinal direction and a second region oriented generally transverse to the longitudinal direction of the housing. A massage member is supported on the carriage for extending in a fore-aft direction and for movement relative to the carriage. The massage member cooperates with the guide such that as the carriage is translated along the guide, the massage member translates longitudinally in the first region of the guide and transversely in the second region of the guide.

Another embodiment discloses a body massager with a housing having an external contact surface for receiving a portion of a body of a user. A longitudinal guide is mounted in the housing. A carriage is oriented in the housing and cooperates with the guide for longitudinal translation in the housing. A suspension is mounted to the carriage. A massage member is supported on the suspension of the carriage for movement along the guide and retraction into the housing in response to a force imparted to the massage member sufficient to compress the suspension.

Yet another embodiment discloses a body massager with a housing having an external contact surface for receiving a portion of a body of a user. A longitudinal guide is mounted in the housing, and is contoured in a fore-aft direction of the housing. A carriage is oriented in the housing and cooperates with the guide for translation in the housing along the guide. A plate is mounted to the carriage for adjustment relative to the carriage in the fore-aft direction. An actuator is mounted to the carriage and the plate for adjusting the plate. A motor-driven rotary massage member is supported on the plate of the carriage for imparting a rotary massage effect and for movement along the guide.

An embodiment discloses a body massager with a housing having an external contact surface for receiving a portion of a body of a user. A longitudinal guide is pivotally connected to the housing. The guide is contoured in a fore-aft direction of the housing. A carriage is oriented in the housing and cooperates with the guide for translation in the housing along the guide. An actuator is mounted to the housing and the guide for adjusting the guide by pivoting the guide relative to the housing. A massage member is supported on the carriage for extending from the housing in the fore-aft direction and for movement along the guide.

Another embodiment discloses a body massager with a housing having an external contact surface for receiving a portion of a body of a user. A longitudinal guide is connected to the housing. The guide is contoured in a transverse direction of the housing. A carriage is oriented in the housing and cooperates with the guide for translation in the housing along the guide. A massage member is supported on the carriage for extending from the housing in a fore-aft direction and for movement along the guide.

Yet another embodiment discloses a body massager with a housing sized to be received and supported by a backrest of a conventional chair. The housing has an external contact surface for receiving a portion of a body of a user. A longitudinal guide is mounted in the housing. The guide is contoured in a fore-aft direction of the housing to extend forward at an upper torso region of the housing, to extend rearward at an intermediate torso region of the housing, and to extend forward at a lower torso region of the housing. A carriage is oriented in the housing and cooperates with the guide for translation in the housing along the guide. A motor-driven rotary massage member is supported on the carriage for imparting a rotary massage effect and for movement along the guide.

### BRIEF DESCRIPTION OF THE DRAWINGS

FIG. 1 is a perspective view of a body massager according to an embodiment of the present invention;

FIG. 2 is a front elevation schematic view of a backrest of the body massager of FIG. 1;

FIG. 3 is a side elevation schematic view of the backrest of the body massager of FIG. 1;

FIG. 4 is a perspective view of a body massager according to another embodiment;

FIG. 5 is a front elevation schematic view of a backrest of the body massager of FIG. 4;

FIG. 6 is a side elevation schematic view of the backrest of the body massager of FIG. 4;

FIG. 7 is a perspective view of a body massager according to another embodiment;

FIG. 8 is a front elevation schematic view of a backrest of the body massager of FIG. 7;

FIG. 9 is a side elevation schematic view of the backrest of the body massager of FIG. 7;

FIG. 10 is a perspective view of a body massager according to another embodiment;

FIG. 11 is a front elevation schematic view of a backrest of the body massager of FIG. 10;

FIG. 12 is a perspective view of a body massager according to another embodiment;

FIG. 13 is a front elevation schematic view of a backrest of the body massager of FIG. 12;

FIG. 14 is a side elevation schematic view of the backrest of the body massager of FIG. 12;

FIG. 15 is a perspective view of a body massager according to another embodiment;

FIG. 16 is a front elevation schematic view of a backrest of the body massager of FIG. 15;

FIG. 17 is a side elevation schematic view of the backrest of the body massager of FIG. 15;

FIG. 18 is a perspective view of a body massager according to another embodiment;

FIG. 19 is a front elevation schematic view of a backrest of the body massager of FIG. 18;

FIG. 20 is a perspective view of a body massager according to another embodiment;

FIG. 21 is a front elevation schematic view of a backrest of the body massager of FIG. 20; and

FIG. 22 is a side elevation schematic view of the backrest of the body massager of FIG. 20.

### DETAILED DESCRIPTION OF EMBODIMENTS

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

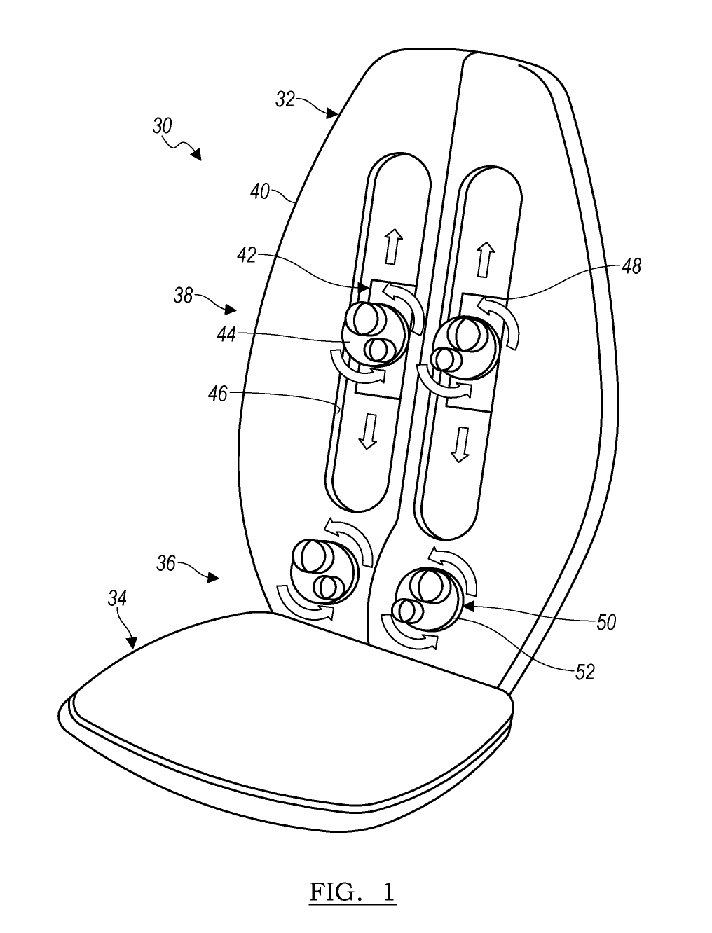

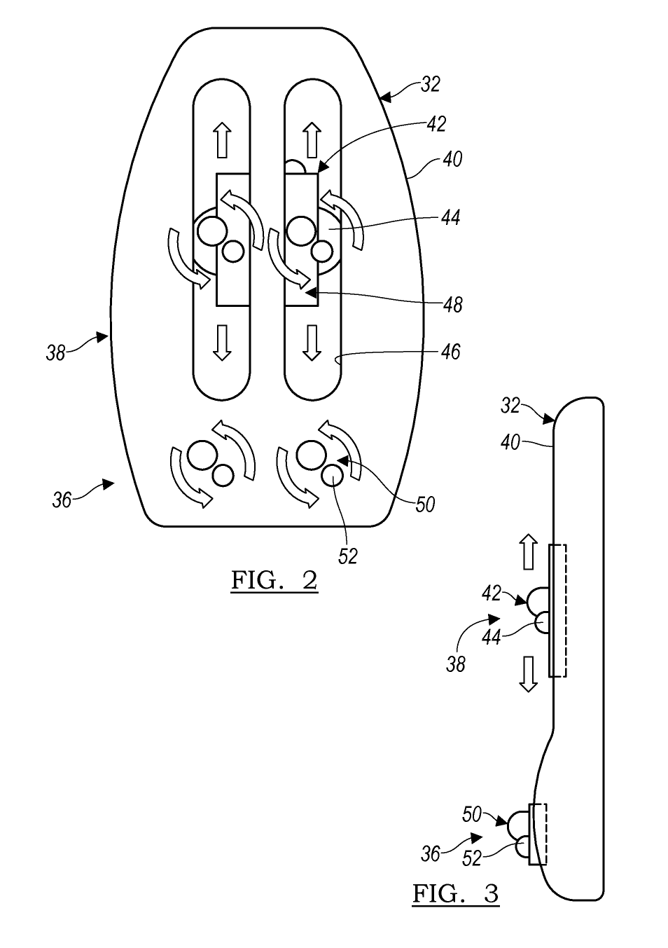

With reference to FIG. 1, a body massager is illustrated according to at least one embodiment and is referenced generally by numeral 30. The body massager 30 is a portable body massager that is sized to be received and supported by a conventional chair. The body massager 30 includes a backrest 32 and a seat support 34. The backrest 32 is also illustrated schematically in FIGS. 2 and 3. The backrest 32 and seat support 34 are collectively retained within a flexible cover, which may be formed of a high quality fabric, leather, vinyl, or the like. The cover may provide a pivotal connection at a lower longitudinal end of the backrest 32 and a rearmost end of the seat support 34. The flexible material of the cover provides a living hinge at the pivotal connection permitting user adjustment of an included angle between the backrest 32 and the seat support 34.

The massage effects provided by the body massager 30 include a massage effect to a lower torso region 36, such as an upper pelvic or lower lumbar region. The lower torso massager effect may be operable to provide a rotary kneading massage effect to the lower torso region 36. The body massager 30 may also include an upper torso massager effect provided in an upper torso region 38 of the backrest 32. The upper torso massage effect may be operable to provide a rotary kneading massage effect longitudinally along the length of the upper torso region 38, which may extend from a lower lumbar region, for example, to a shoulder and neck region.

In at least one embodiment, the backrest 32 is sized to be received upon a backrest of a conventional chair. Likewise, the seat support 34 is sized to be received upon a seat support of a conventional chair. The lower torso region 36 of the backrest 32 is sized to receive and support a lower torso region of a user, such as the pelvic region, or the pelvic region and a lower lumbar region of the torso. The upper torso region 38 is sized to receive and support an upper torso region of the user, such as an upper lumbar region, thorax, shoulders, and neck.

In at least one embodiment, the body massager 30 is portable due to its compact size and lightweight so that the user may place the body massager 30 upon a conventional chair for receiving a massage effect when seated upon a chair. The adjustability of the included angle between the backrest 32 and the seat support 34 accommodates a wide range of angles that may be incorporated in conventional chairs. Alternatively, the body massager 30 may be utilized without a chair for various seating and resting positions. Alternatively, the body massager 30 may be utilized upon a vehicular seat.

The backrest 32 includes a height and width corresponding to the conventional chair and has a thickness that is adequate for housing massage assemblies therein while avoiding disruption of comfort and support provided by the underlying chair. Likewise, the seat support 34 has a width and a depth corresponding to that of the conventional seat support and has a thickness that is adequate for housing a cushion while avoiding disruption of comfort and support provided by the underlying chair. Additionally, the backrest 32 may include a pair of straps mounted from its lateral sides for securing the body massager 30 to the conventional chair. The body massager 30 further includes a manual remote controller (not shown) connected to the massager 30 for controlling the massage operations.

In FIGS. 1-3, the backrest 32 is illustrated removed from the cover. The backrest 32 includes a housing 40 for providing an external contact surface for the back of the user and for retaining the massage assemblies of the lower and upper torso regions 36, 38.

An upper torso massage assembly 42 is provided in the upper torso region 38 of the housing 40. The upper torso massage assembly 42 in one embodiment, is a rotary kneading massager with a pair of massage heads 44 each extending through a lengthwise opening 46 in the housing 40. The massage heads 44 are each driven to rotate relative to the housing 40 for collectively providing a rotary kneading massage effect. For example, the massage heads 44 may be counter-rotating for providing a shiatsu massage effect. The massage heads 44 are mounted for rotation upon a carriage 48 within the housing 40. The carriage 48 cooperates with a guide within the housing 40 for driving the massage heads 44 longitudinally to provide a rolling massage effect upon a length of the upper torso region 38. As the massage heads 44 are rotated, a longitudinal rotary kneading massage effect may be provided.

Suitable massage assemblies for providing the longitudinal rolling massage effect and rotary massage effect of the upper torso massage assembly 42 are known in the art. One such example is disclosed in U.S. Pat. No. 7,128,721 B2, which issued to Ferber et al. on Oct. 31, 2006 and is incorporated by reference herein. The '721 patent discloses a massage assembly having a single motor for driving the carriage in the lengthwise direction while rotating the associated massage heads. Another suitable massage assembly is disclosed in U.S. Pat. No. 7,470,242 B2, which issued to Ferber et al. on Dec. 30, 2008 and is incorporated by reference herein. The '242 patent discloses a two motor design with one motor for driving the carriage lengthwise and another motor for providing the rotary massage effect. Of course, other suitable massage assemblies are contemplated within the spirit and scope of the embodiments of the present invention.

The lower torso region 36 includes a lower torso massage assembly 50, which includes a pair of rotary massage heads 52 that are spaced about a center longitudinal axis of the backrest 32 and are driven to provide a rotary kneading massage effect. Unlike the upper torso massage assembly 42, the lower torso massage assembly 50 does not include a carriage and therefore provides a targeted rotary kneading massage effect.

As illustrated in FIG. 3, the seat back 32 is contoured to accommodate a back of the user. For example, the lower torso region 36 is thicker to extend further from the chair than the upper torso region 38 for contacting the lower torso region of the user. Likewise, the lower torso massage assembly 50 extends further forward than the upper torso massage assembly 42 for contacting the user. Additionally, by providing the lower torso massage assembly 50 further forward than the upper torso massage assembly 42, clearance is provided within the housing 40 for the carriage 48 of the upper torso massage assembly 42 to extend rearward of the lower torso massage assembly 50.

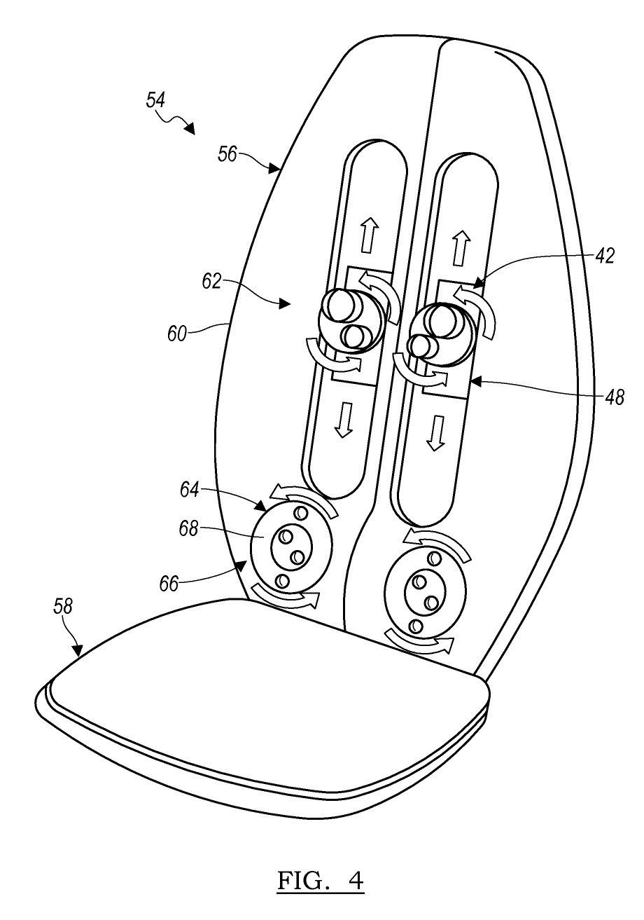

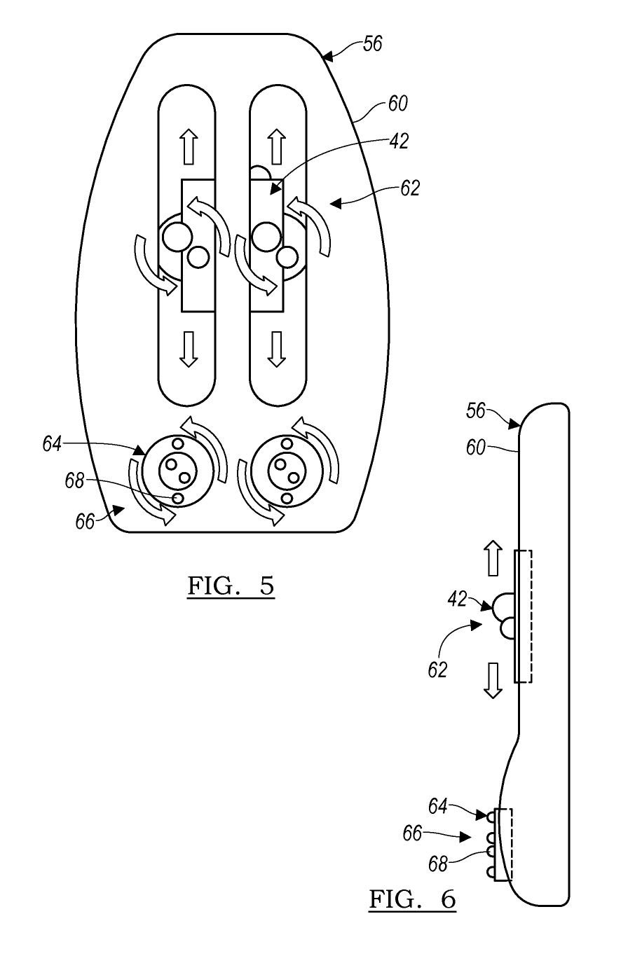

Referring now to FIGS. 4-6, another body massager 54 is illustrated according to another embodiment. The body massager 54 is similar to the prior embodiment. The body massager 54 includes a backrest 56 and a seat support 58. The backrest 56 has a housing 60 with the upper torso massage assembly 42 in an upper torso region 62. The massager 54 also has a lower torso massage assembly 64 in a lower torso region.

The lower torso massage assembly 64 differs from the prior embodiment in that it has a pair of massage heads 68 that each provide counter rotating massage with an outer massage member and an inner massage member that are driven for reverse rotation. U.S. Pat. No. 7,322,946 B2, which issued on Jan. 29, 2008 to Lev et al. discloses a suitable massage apparatus for providing the counter rotating massage and is incorporated by reference herein.

Similar to the prior embodiment, the housing 60 is contoured with an enlarged lower torso region 66 for matching the contour of a back of the user. Additionally, the lower torso massage assembly 64 is provided forward relative to the upper torso massage assembly 42 for contacting the back of the user and for providing clearance for the carriage 48 to extend to a lower region of the housing 60.

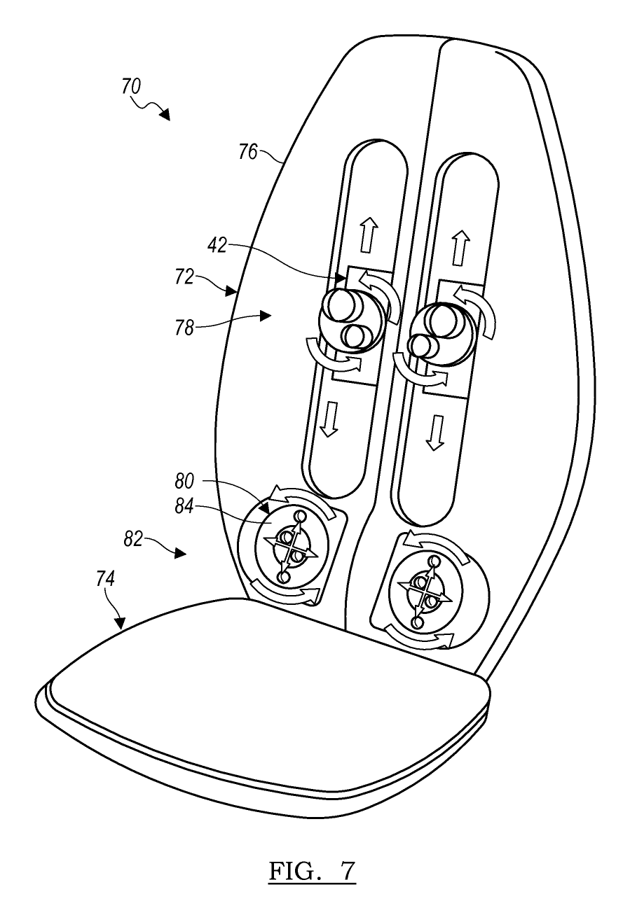

FIGS. 7-9 illustrate a body massager 70 according to yet another embodiment. The body massager 70 is similar to prior embodiments and includes a backrest 72 and a seat support 74. The backrest 72 includes a housing 76 for retaining the upper torso massage assembly 42 in an upper torso region 78 and a lower torso massage assembly 80 in a lower torso region 82.

The lower torso massage assembly 80 includes a pair of massage heads 84 for providing a rotary kneading massage effect driven by a motor 81. The massage heads 84 may be similar to the massage heads 68 of the embodiment of FIGS. 4-6 to provide a counter rotating massage from each massage head 84. Alternatively, the massage heads 84 may each provide unidirectional rotation such as those provided in the upper torso massage assembly 42.

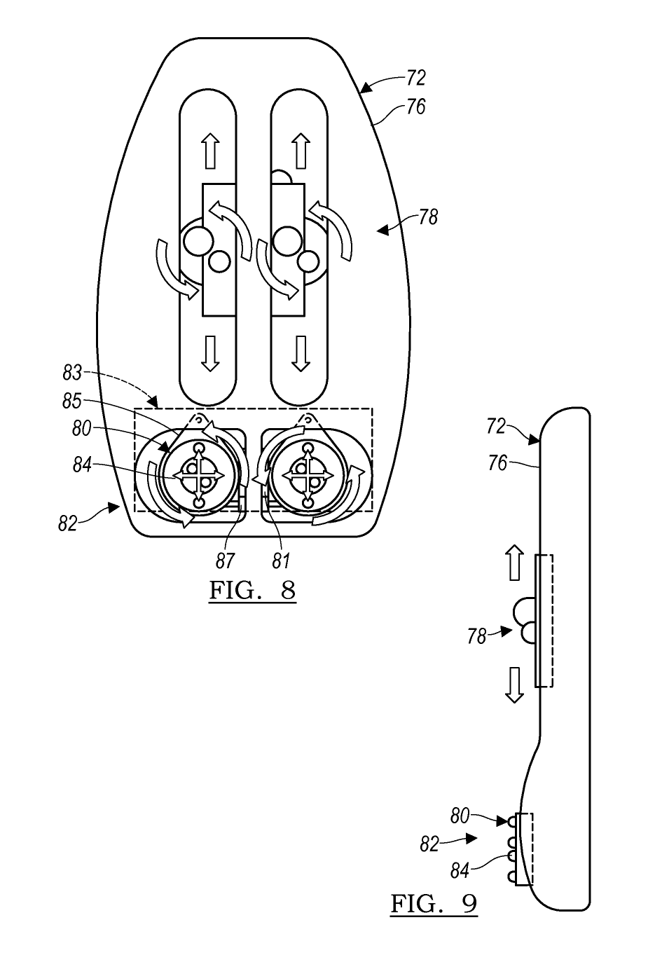

The lower torso massage assembly 80 is supported upon a carriage 83 (FIG. 8) for travel in a lengthwise direction of the seat back housing 76. The lengthwise travel permits the user to select a desired location for the massage assembly 80 for receiving the rotary massage effect. Additionally, each of the massage heads 84 are mounted upon the carriage 83 for movement in a transverse direction for permitting the user to select a desired width. In order to provide the width adjustment in a transverse direction, the massage heads 84 may each be driven by a pivotal gear box 85, such as that disclosed for width adjustment of massage heads in Ferber et al. U.S. Patent Application Publication No. 2008/0262398 A1, which published on Oct. 23, 2008 and is incorporated by reference herein. In order to adjust the width of the massage heads 84, an actuator, such as a motor driven gear assembly 87 may be employed for driving a rack connected to the pivotal gear box 85 of each of the massage heads 84. Of course, other actuators for adjusting the width of the massage heads 84 is contemplated within the spirit and scope of the present invention.

Referring to FIG. 9, the housing 76 has a contoured shape to comfortably support the back of a user and to provide the massage assemblies 42, 80 in contact with the associated regions.

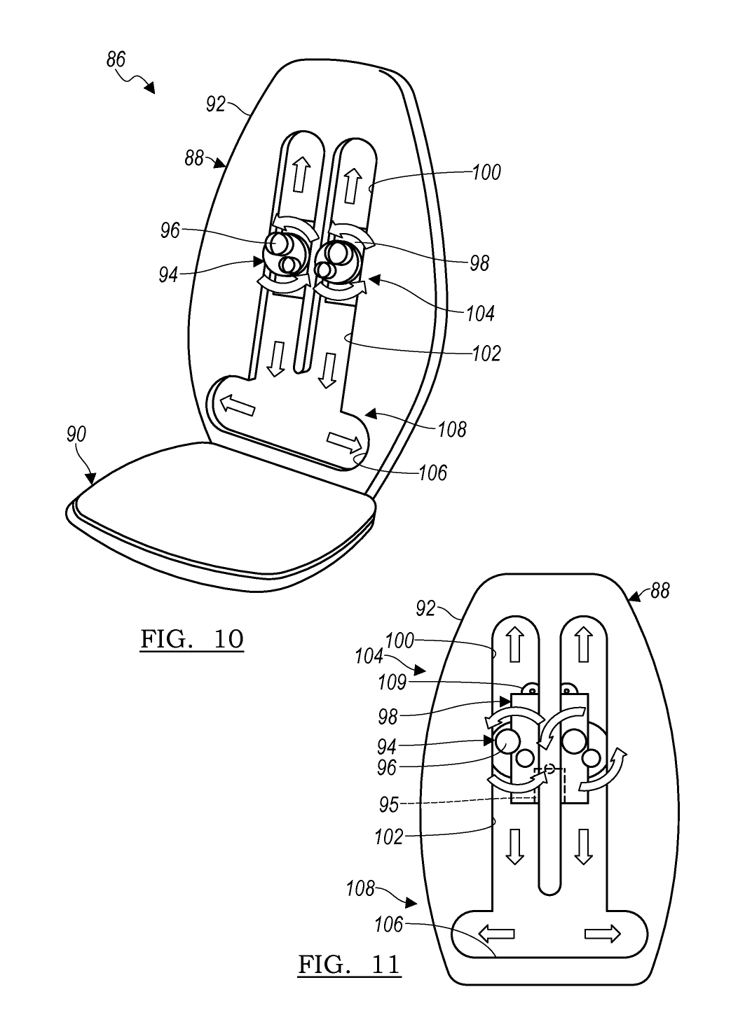

FIGS. 10 and 11 illustrate a body massager 86 according to another embodiment, which is similar to prior embodiments. The body massager 86 includes a backrest 88 and a seat support 90. The backrest 88 includes a housing 92 for retaining a massage assembly 94 driven by a motor 95 for providing a counter rotating massage effect from a pair of massage heads 96. The massage assembly 94 is mounted to a carriage 98 which cooperates with a guide of the housing 92 for travel in a lengthwise direction of the backrest 88.

The housing 92 includes an opening 100 so that the massage heads 96 can extend through the housing 92 and engage the user. The opening 100 includes a pair of lengthwise slots 102 in an upper torso region 104 that extend to a transverse slot 106 formed through a lower torso region. The massage heads 96 are configured to extend outboard in the transverse slot 106 when the carriage 98 is in a lower torso region 108 to provide a rotary kneading massage effect to a laterally outward region of the user's lower torso region.

In order to provide the transverse extension of the massage heads 96 in the transverse slot 106, each of the massage heads 96 is mounted to the carriage 98 by a pivotal gearbox 109 such as those disclosed in the '398 application which has been incorporated by reference. The pivotal gearboxes 109 are each pivotally connected to the carriage 98 laterally inboard from a center line of the lengthwise slots 102 for extension to a position that is laterally outboard of the lengthwise slots 102. As the carriage 98 travels downward in the backrest housing 92, the massage heads 96 engage the transverse slots 106. Further downward travel of the carriage 98 causes the massage heads 96 to pivot about the gearboxes 109, which is offset from the direction of rotation of the massage heads 96. Thus, further downward travel of the carriage 98 causes each of the massage heads 96 and associated gearbox 109 to pivot generally outboard due to the inboard pivotal connection. When the carriage 98 reaches a lowermost position, the massage heads 96 are each pivoted to an extended position away from the carriage 98, which is upward and outboard relative to the position illustrated in FIGS. 10 and 11.

Likewise, when the carriage 98 travels upward from the lowermost position, the massage heads 96 and associated gearboxes 109 pivot inward to a retracted position until they are aligned with the lengthwise slots 102. Then further upward travel conveys the massage heads 96 within the lengthwise slots 102 for a linear rotary kneading massage path in the upper torso region 104. Of course, various paths for the massage heads 96 are contemplated within the scope of embodiments of the invention in order to convey the massage heads 96 along a desired path.

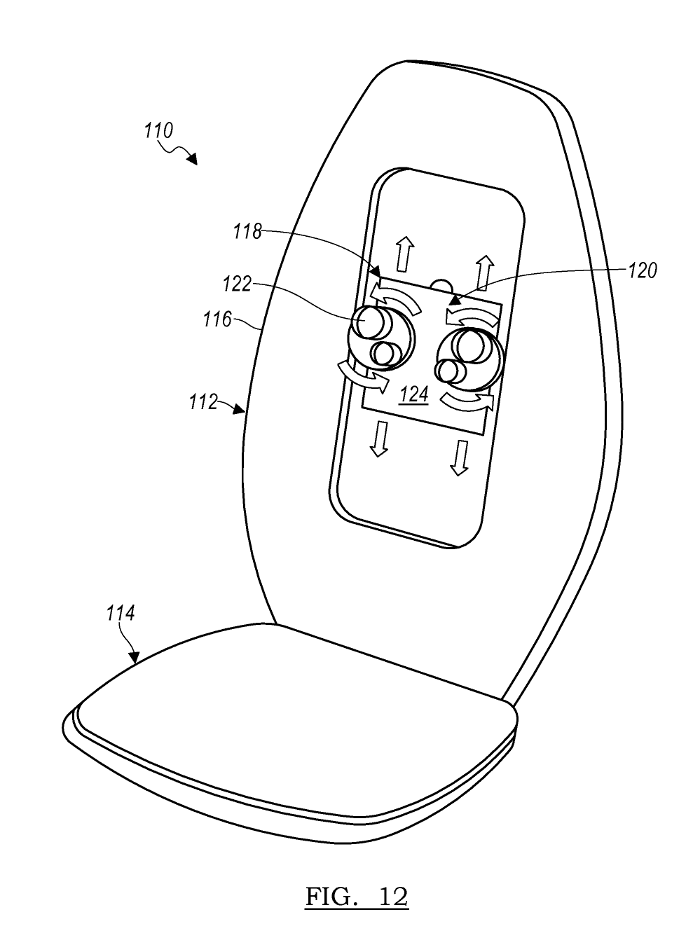

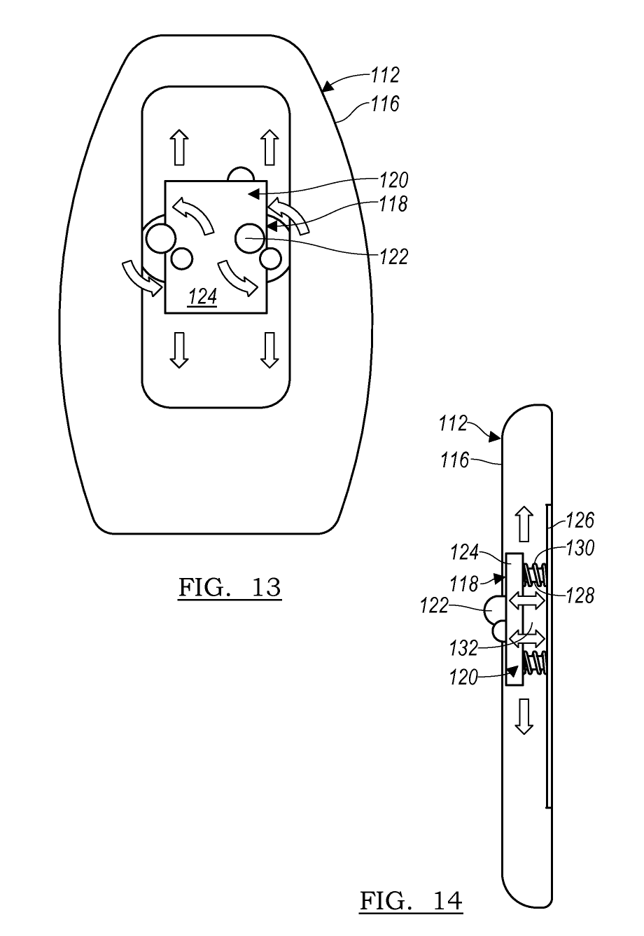

With reference to FIGS. 12-14, a body massager 110 is illustrated according to another embodiment. Similar to the prior embodiments, the body massager 110 includes a backrest 112 and a seat support 114. The backrest 112 includes a housing 116 for retaining a massage assembly 118. Similar to prior embodiments, the massage assembly 118 includes a carriage 120 that is mounted to a guide within the housing 116 for translation in a lengthwise direction. A pair of rotary massage heads 122 are mounted to the carriage 120 for providing a rotary kneading massage effect to the back of the user.

According to one embodiment, the carriage 120 includes an adjustable plate 124, which is adjustable relative to a guide 126 in the housing 116. The massage heads 122 are mounted to the plate 124 such that adjustment of the plate 124 relative to the guide 126 varies the intensity of the massage effect. For example, the adjustable plate 124 is mounted to the carriage 126 by a plurality of shafts 128. A compression spring 130 is provided on each shaft 128 to spring load the adjustable plate 124. The compression of the springs 130 is adjustable for adjusting the intensity of the massage effect. For example, an actuator 132 is provided in the carriage 120 for further compressing the compression springs 130 for reducing the compliancy, thereby increasing the intensity of the massage effect. Likewise, controlling the actuator 132 to reduce the compression upon the springs 130 enhances the compliancy thereby requiring less force for the user to retract the plate 124 when leaning against the massage heads 124, which consequently reduces the intensity of the massage effect. Any suitable actuator for adjusting the compression of the compression springs 130 is contemplated, such as a motor driven actuator or the like. The adjustment of the actuator 132 is provided in a controller for the massage 110, such as a wired or wireless remote controller as are known in the art.

According to another embodiment, the springs 130 are utilized for extending the plate 124 to a forward direction as illustrated by the linear horizontal arrows in FIG. 14. Instead of adjusting the compression of the springs 130, the actuator 132 cooperates with the guide 126 and the adjustable plate 124 for retracting the adjustable plate 124 into the housing 116. According to this embodiment, the user can control a depth of which the massage heads 122 extend from the housing 116, thereby controlling the intensity of the massage effect.

According to the various embodiments depicted in FIGS. 12-14 and other embodiments disclosed herein, the intensity can be varied along the length of travel of the carriage 120, thereby permitting the user to customize the massage as desired, or to match the contour of the particular user's back. Such adjustments are programmable within the controller of the massager 110 so that the user can program a desired massage or a massage program that is customized for a particular user for repeated selection or for selection of preferences. The controller is configured to store programs for various users, which may be selected by selecting the user and selecting the user's program number.

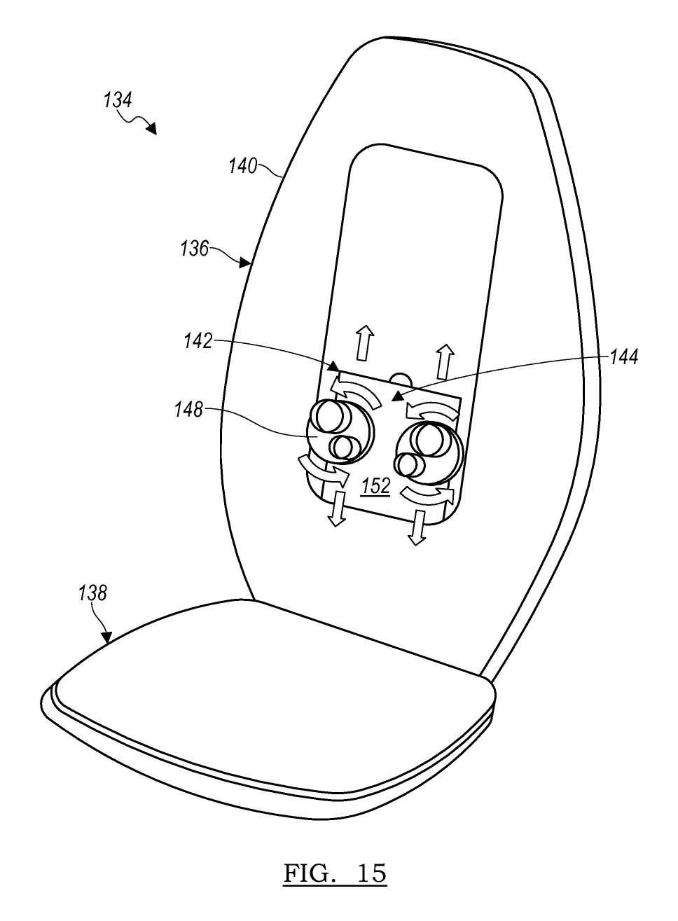

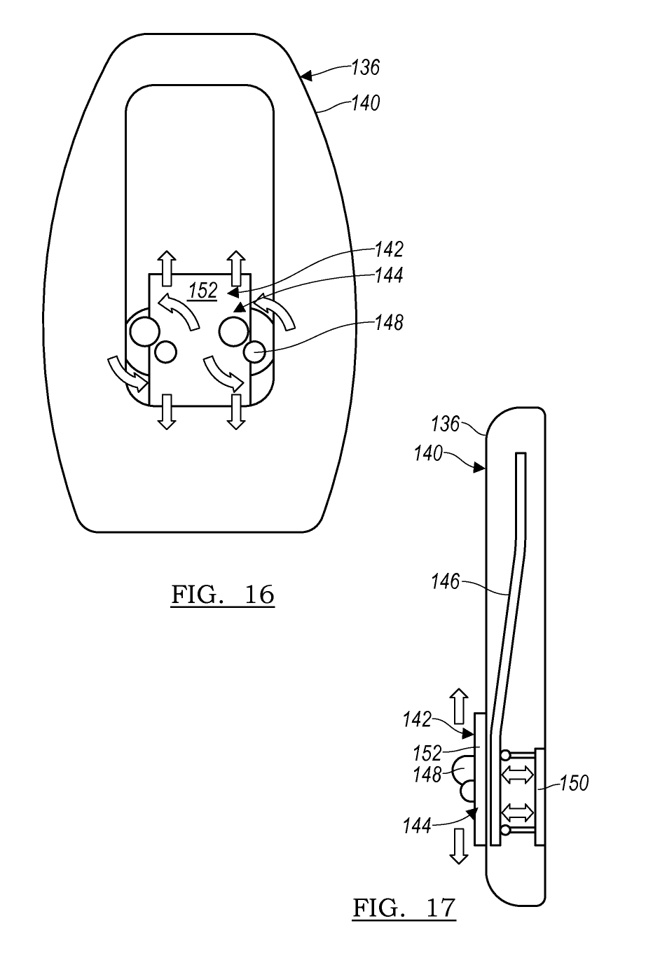

Another body massage 134 is illustrated in FIGS. 15-17. Similar to the prior embodiments, the body massager 134 has a backrest 136 and a seat support 138. The seat support 138 has a housing 140 with a massage assembly 142 therein. The massage assembly 142 includes a carriage 144 that translates lengthwise within the housing 140 along a guide 146. A pair of massage heads 148 are provided upon the carriage 144 for providing a rotary kneading massage effect to the user as the carriage 144 translates within the housing 140. The guide 146 is contoured to match the contour of a user's back as illustrated in FIG. 17. In order to provide adjustment of the contour, the carriage 144 includes an actuator 150 that cooperates with the guide 146 and an adjustable plate 152 of the carriage 144. The massage heads 148 are mounted to the adjustable plate 152 for adjustment of depth relative to the guide 146. Thus, a user can modify a position of the massage heads 148 relative to the contoured guide 146 to select a rotary kneading massage effect that is customized to the particular user's back, or is customized to provide a desired massage effect.

Alternatively, the guide 146 may be pivotally connected to the housing 140 at one end, such as an upper end. The guide 146 may also be connected to a fixed actuator, such as actuator 150 so that adjustment of the actuator 150 adjusts the angle of the guide 146 relative to the housing 140 to adjust the contour of the guide 146 relative to the housing 140.

An example of a suitable massage assembly having a carriage with rotary kneading massage members that cooperates with a contoured guide is disclosed in U.S. Patent Application Ser. No. 61/026,897, which was filed on Feb. 7, 2008 by Meyer et al., the disclosure of which is incorporated by reference herein. Another suitable massage assembly having a carriage with rotary kneading massage members that cooperates with a contoured guide is disclosed in U.S. Patent Application Ser. No. 61/106,714, which was filed on Oct. 20, 2008 by Ferber et al., the disclosure of which is incorporated by reference herein.

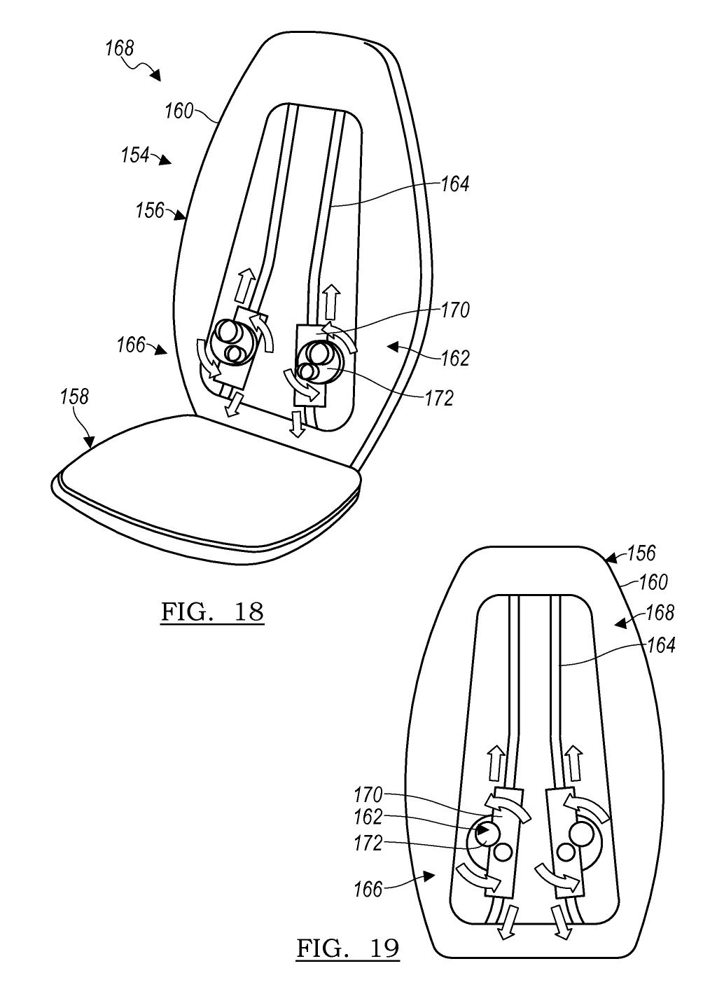

Another body massager 154 is illustrated in FIGS. 18 and 19 according to at least one embodiment. The body massager 154 includes a backrest 156 and a seat support 158. The backrest 156 includes a housing 160 with a massage assembly 162. The massage assembly 162 includes a pair of guides 164 in the housing 160 that diverge at a lower torso region 166 of the backrest 156 and converge at an upper torso region 168 of the backrest 156. The massage assembly 162 includes a pair of carriages 170, each mounted to one of the guides 164. A massage head 172 is provided on each carriage 170 to provide a rotary kneading massage effect.

The carriages 170 are each driven upon the respective guide 164 in order to provide a rotary kneading massage effect that converges in the upper torso region 168 and diverges in the lower torso region 166. The carriages 170 may be driven concurrently or individually for varying the desired massage effect. By diverging the massage heads 172 at the lower torso region 166 a targeted massage effect can be generated that is centralized in the upper torso region 168 but is broadened at the lower torso region 166.

The carriages 170 may be interconnected and driven concurrently with an individual drive. Alternatively, a common carriage may be provided and the massage heads 172 may each be provided with a pivotal transmission gear case 170 that cooperates with the guide 164 to pivot the respective massage head 172 relative to the underlying carriage.

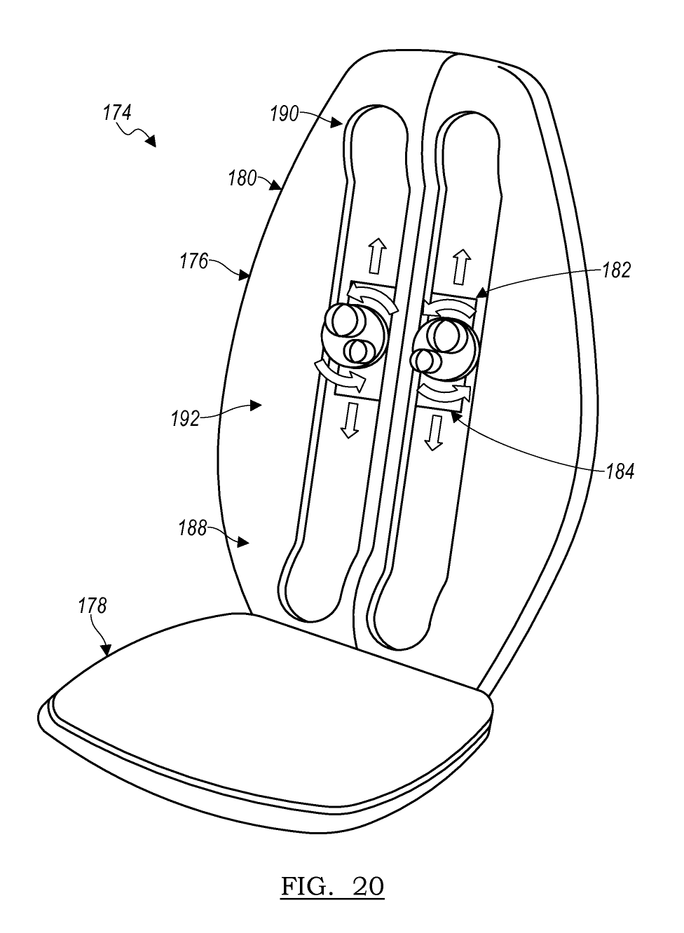

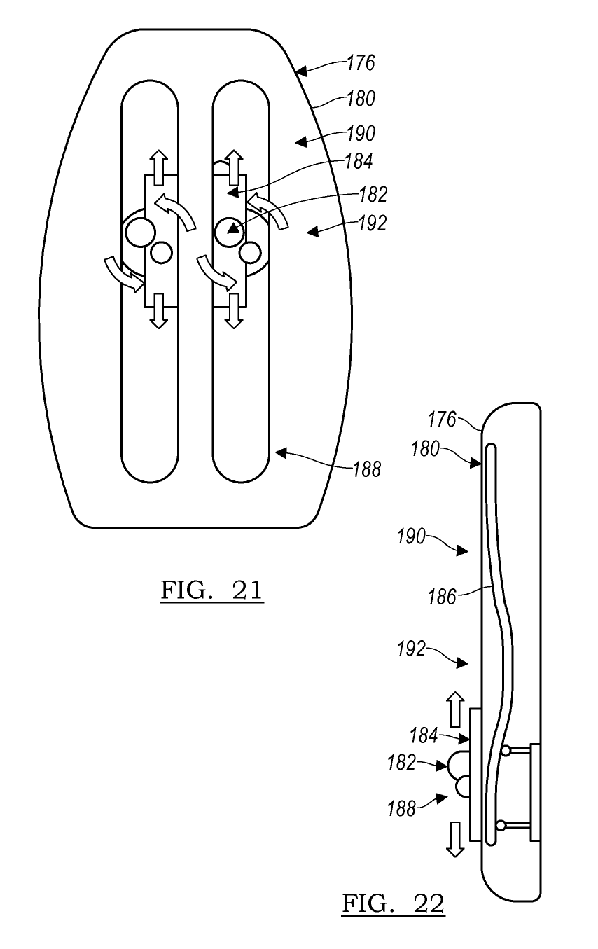

FIGS. 20-22 depict a body massager 174 according to another embodiment. The body massager 174 is similar to prior embodiments and includes a backrest 176 and a seat support 178. The backrest 176 includes a housing 180, which retains a massage assembly 182. Similar to the embodiment of FIGS. 15-17, the massage assembly 182 includes a carriage 184 that cooperates with a contoured guide 186. The contoured guide 186 extends forward relative to the housing 180 in a lower torso region 188 and an upper torso region 190. The guide 186 may extend rearward relative to the housing 180 in an intermediate torso region 192. The guide 186 may have a length greater than that of prior embodiments and may be contoured to provide a targeted massage that extends forward in the lower torso region 188 to contact the upper pelvic and lower lumbar regions. Likewise, the guide 186 may retract in the intermediate torso region 192 for cooperating with the upper lumbar and lower thorax regions. Likewise, the guide 186 may be contoured forward again in the upper torso region 190 for maintaining contact with the upper thorax regions and the shoulders and neck. Thus, various contours may be provided to adequately massage the contours of various users body. Similar to prior embodiments, the carriage 184 and/or guide 186 may be adjustable for customization of the desired massage effect.

In the preceding embodiments, although rotary kneading massage assemblies are depicted and described, various massage assemblies are contemplated within various embodiments of the present invention. For example, rolling massage effects may be provided in cooperation with the associated massage carriages and roller kneading massage effects may be provided by oscillating the rollers relative to the carriage. One suitable roller massage assembly for providing various roller massage effects is disclosed in U.S. Pat. No. 7,419,475 B2, which issued to Ferber et al. on Sep. 2, 2008 and is incorporated by reference herein.

The invention contemplates embodiments that employ in combination, features of various embodiments described above. For example, one of the massage assemblies of the embodiments of FIGS. 1-9 can be added to any of the embodiments of FIGS. 10-22. Additionally, the transverse travel features of FIGS. 10, 11, 18 and 19 can be added to any of the embodiments of FIGS. 1-9, 12-17 and 20-22. Additionally, the fore-aft adjustment or travel features of FIGS. 12-17 and 20-22 can be added to any of the embodiments of FIGS. 1-11 and 18-22.

In the various embodiments discussed above, the massage effects may be provided in combination with other therapeutic effects. For example, the massage effects may be provided in combination with a heat therapy effect. Examples of suitable heaters that may employed are disclosed in International Patent Application WO 2009/061309 A1 which published on May 14, 2009 to Ferber et al. and is incorporated by reference herein.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. Additionally, features of various implementing embodiments may be combined to form further embodiments of the invention.

What is claimed is:

1. A body massager comprising:
a backrest housing sized to be received and supported by a backrest of a conventional chair;
a seat support pivotally connected to the backrest housing;
a carriage oriented in the housing and cooperating with the housing for longitudinal translation in an upper torso region of the housing;
a first motor-driven massager mounted on the carriage and extending in a forward direction from the housing for imparting a first kneading massage effect; and
a second motor-driven massager mounted to the housing at a lower torso region between the first region and the seat bottom, the second motor-driven massager extending in the forward direction from the housing further than the first motor-driven massager for imparting a second kneading massage effect.

2. The body massager of claim 1 wherein the lower torso region of the housing is thicker than the upper torso region in the forward direction of the housing.

3. The body massager of claim 1 wherein the second motor-driven massager provides a rotary kneading massage effect.

4. The body massager of claim 1 wherein the second motor-driven massager further comprises a pair of inner massage members, and a pair of outer massager members each oriented about one of the pair of inner massage members to provide a counter-rotating kneading massage effect.

5. The body massager of claim 1 further comprising a second carriage oriented in the housing and cooperating with the housing for longitudinal translation in the lower torso region of the housing;
wherein the second motor-driven massager is mounted on the second carriage.

6. The body massager of claim 5 wherein the second motor-driven massager further comprises:
a motor mounted to the carriage;
a pair of gearboxes mounted to the carriage and operably connected to the motor for being driven by the motor;
a pair of massage members each mounted to one of the pair of gearboxes for being driven by the corresponding gearbox; and
an actuator mounted to the carriage and operably connected to the pair of gearboxes for adjusting a transverse position of the gearboxes and the massage members.

7. A body massager comprising:
a housing having an external contact surface for receiving a portion of a body of a user;
a carriage oriented in the housing and cooperating with the housing for longitudinal translation in a longitudinal direction of the housing;
a guide mounted to the housing having a first region extending in the longitudinal direction and a second region oriented generally transverse to the longitudinal direction of the housing; and
at least one massage member supported on the carriage for extending in a fore-aft direction and for movement relative to the carriage, the at least one massage member cooperating with the guide such that as the carriage is translated along the guide, the at least one massage member translates longitudinally in the first region of the guide and transversely in the second region of the guide.

8. The body massager of claim 7 wherein the housing is sized to be received and supported by a backrest of a conventional chair; and
wherein the second region of the guide is further defined as a lower torso region.

9. The body massager of claim 7 further comprising:
a motor mounted to the carriage; and
a pair of gearboxes mounted to the carriage and operably connected to the motor for being driven by the motor;
wherein the at least one massage member further comprises a pair of massage members each mounted to one of the pair of gearboxes for being driven by the corresponding gearbox.

10. The body massager of claim 9 wherein the pair of gearboxes are each pivotally connected to the carriage.

11. A body massager comprising:
a housing having an external contact surface for receiving a portion of a body of a user;
a longitudinal guide mounted in the housing;
a carriage oriented in the housing and cooperating with the guide for longitudinal translation in the housing;
a suspension mounted to the carriage; and
at least one massage member supported on the suspension of the carriage for movement along the guide and translation into the housing in response to a force imparted to the massage member sufficient to compress the suspension.

12. The body massager of claim 11 further comprising an actuator mounted to the carriage in operable connection with the suspension for compressing the suspension for reducing compliancy of the suspension thereby enhancing an intensity of a massage effect.

13. The body massager of claim 11 further comprising an actuator mounted to the carriage in operable connection with the at least one massage member for controlling a depth of the at least one massage member.

14. A body massager comprising:
a housing having an external contact surface for receiving a portion of a body of a user;
a longitudinal guide mounted in the housing, the guide being contoured in a fore-aft direction of the housing;
a carriage oriented in the housing and cooperating with the guide for translation in the housing along the guide;
a plate mounted to the carriage for adjustment relative to the carriage in the fore-aft direction;
an actuator mounted to the carriage and the plate for adjusting the plate; and
at least one motor-driven rotary massage member supported on the plate of the carriage for imparting a rotary massage effect and for movement along the guide.

15. A body massager comprising:
a housing having an external contact surface for receiving a portion of a body of a user;
a longitudinal guide adjustably connected to the housing, the guide being contoured in a fore-aft direction of the housing;
a carriage oriented in the housing and cooperating with the guide for translation in the housing along the guide;
an actuator mounted to the housing and the guide for adjusting the guide relative to the housing; and
at least one massage member supported on the carriage for extending from the housing in the fore-aft direction and for movement along the guide.

16. The body massager of claim 15 wherein the guide is pivotally connected to the housing.

17. A body massager comprising:
a housing having an external contact surface for receiving a portion of a body of a user;
a longitudinal guide connected to the housing, the guide being contoured in a transverse direction of the housing;
a carriage oriented in the housing and cooperating with the guide for translation in the housing along the guide; and
at least one massage member supported on the carriage for extending from the housing in a fore-aft direction and for movement along the guide.

18. The body massager of claim 17 further comprising:
a second longitudinal guide connected to the housing, the second guide being contoured in the transverse direction of the housing;
a second carriage oriented in the housing and cooperating with the second guide for translation in the housing along the second guide; and
at least a second massage member supported on the second carriage for extending from the housing in the fore-aft direction and for movement along the second guide.

19. The body massager of claim 18 wherein the housing is sized to be received and supported by a backrest of a conventional chair; and
wherein the first and second guides diverge at a lower torso region of the housing.

20. A body massager comprising:
a housing sized to be received and supported by a backrest of a conventional chair, the housing having an external contact surface for receiving a portion of a body of a user;
a longitudinal guide mounted in the housing, the guide being contoured in a fore-aft direction of the housing to extend forward at an upper torso region of the housing, to extend rearward at an intermediate torso region of the housing, and to extend forward at a lower torso region of the housing;
a carriage oriented in the housing and cooperating with the guide for translation in the housing along the guide; and
at least one motor-driven rotary massage member supported on the carriage for imparting a rotary massage effect and for movement along the guide.
